(19) United States
(12) Patent Application Publication
(10) Pub. No.: US 2018/0129176 A1
(43) Pub. Date: May 10, 2018

(54) REAL-TIEM SIMULATION SYSTEM

(71) Applicant: Gathertech Intelligent Automation CO., LTD., Tainan City (TW)

(72) Inventors: Chien-Yu Chi, Tainan City (TW); Hsin-Hsiang Lan, Tainan City (TW)

(21) Appl. No.: 15/620,021

(22) Filed: Jun. 12, 2017

(30) Foreign Application Priority Data
Nov. 9, 2016 (TW) 105136508

(51) Int. Cl. G05B 17/02; G05B 23/02

(52) U.S. Cl. CPC G05B 17/02; G05B 23/0202; G05B 23/0243; G05B 23/0216

(57) ABSTRACT

The present disclosure provides a real-time simulation system for testing a controller, which outputs a control signal for controlling operations of a power converter and an AC motor. The real-time simulation system comprises a real-time simulation module, a load simulation module and an operation management and monitoring module. The real-time simulation module constructs a first model simulating the dynamic behaviors of the AC motor coupled to the mechanical load. The real-time simulation module operates a simulation program for generating a first simulation result. The load simulation module constructs a second model simulating dynamic behaviors of the mechanical load and generates a second simulation result by a simulation program. The real-time simulation module can adjust the simulation program to the first model according to the second simulation result. The operation management and monitoring module monitors the operation of the real-time simulation module and the load simulation module.

### CROSS-REFERENCE TO RELATED APPLICATION

This application claims priority to Taiwan Patent Application No. 105136508, filed on Nov. 9, 2016, the entire content of which is incorporated herein by reference for all purposes.

### FIELD OF THE DISCLOSURE

The present disclosure relates to a real-time simulation system, and more particularly to a real-time simulation system capable of testing the controller for the power converter and the AC motor and instantaneously monitoring the simulation state.

### BACKGROUND OF THE DISCLOSURE

A general AC motor driving system includes two major parts, a power converter and a controller. The controller outputs the control signals to the power converter and receives information, like sensor signals, from the power converter. The power converter converts the input power according to the control signals and adjusts the amplitude and the frequency of the output voltage to the AC motor. With sophisticated design of the control signals, the driving system is able to enhance the functioning (e.g., the rotational speed, the output torque, etc.) of the AC motor. Undoubtedly, the controller is one of the most critical components that affect the performance of the AC motor. A comprehensive testing of the controller is necessary to ensure the quality of the AC motor driving system.

Conventionally, the controller is tested manually with real machines, where the controller, the power converter, and the AC motor are connected. Different profiles of mechanical load (also known as test scenarios) are applied to the AC motor by a coupled machine, such as the other AC motor, to verify the performance of the controller. Consequently, the cost spent on the conventional testing procedure is very high, due to the power consumption and the facilities expenses. Moreover, the operators may face a lot of risk while doing the limit tests with real machines, especially in the early stage of system development.

Thanks to the growth of computing and electronic technology, the performance of the controller can be verified by a real-time simulation system instead of real machines. Many of the test scenarios for the controller can be virtually generated by computers. A common real-time simulation system simulates the test scenarios, like the dynamics of AC motor and mechanical loads, with one or multi parallel processors. In this kind of testing, the controller outputs are connected to the computer interfaces, and the corresponding dynamic responses of the rest of driving system are simulated by the computer and sent back to the controller inputs via the other computer interfaces. The closed-loop verification of the controller performance can then be done without high power consumption and real machines.

However, the dynamic responses (or say bandwidth in frequency domain) of the parts of the driving system are quite different, for example, the power converter has fastest response and the mechanical load has slowest response. The computational resource may not be well employed and distributed in the common real-time simulation system. In addition, it is complicated on system modeling and deployment in the common real-time simulation systems, such that the applicability of the common real-time simulation system to different kind of controllers is low.

Therefore, there is a need of providing a real-time simulation system to obviate the drawbacks encountered from the prior arts.

### SUMMARY OF THE DISCLOSURE

The purpose of the present disclosure is to provide a real-time simulation system for higher safety, higher applicability, higher computational resource efficiency and lower cost.

The present disclosure provides a real-time simulation system for testing a controller. The controller outputs a control signal for controlling operations of a power converter and an AC motor and allows the AC motor to drive a mechanical load synchronously. The real-time simulation system comprises a real-time simulation module, a load simulation module and an operation management and monitoring module. The real-time simulation module constructs a first model simulating dynamic behaviors of a power received by the power converter, the power converter and the AC motor coupled to the mechanical load. The real-time simulation module substitutes the control signal into the first model and operates a simulation program for generating a first simulation result when the real-time simulation module receives the control signal. The real-time simulation module comprises a first communication interface and at least one first output and input unit. The at least one first output and input unit transmits the first simulation result to the controller and receives the control signal. The load simulation module constructs a second model simulating the dynamic behaviors of the mechanical load and generates a second simulation result by a simulation program. The load simulation module comprises a second communication interface and at least one second output and input unit. The second communication interface communicates with the first communication interface. The second simulation result is transmitted to the at least one first output and input unit via the at least one second output and input unit, or transmitted to the first communication interface via the second communication interface, for allowing the real-time simulation module to adjust the simulation program to the first model according to the second simulation result. The operation management and monitoring module monitors the operations of the real-time simulation module and the load simulation module. The operation management and monitoring module comprises a human-machine interface, a display unit and a third communication interface. The third communication interface communicates with the first communication interface for allowing the operation management and monitoring module and the real-time simulation module to communicate with each other. The third communication interface communicates with second communication interface via the first communication interface for allowing the operation management and monitoring module and the load simulation module to communicate with each other. The display unit displays the operation states of the real-time simulation module, the operation state of the load simulation module, the first simulation result and the second simulation result. The human-machine interface receives a user command and sets parameters of the first model according to the user command via the third communication interface and the first communication interface. The human-machine interface sets parameters of the second model according to the user command via the third communication interface, the first communication interface and the second communication interface.

### BRIEF DESCRIPTION OF THE DRAWINGS

FIG. 1 is a circuit diagram illustrating a real-time simulation system according to an embodiment of the present disclosure; and

FIG. 2 is a circuit diagram illustrating a variant example of the real-time simulation system shown in FIG. 1 of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

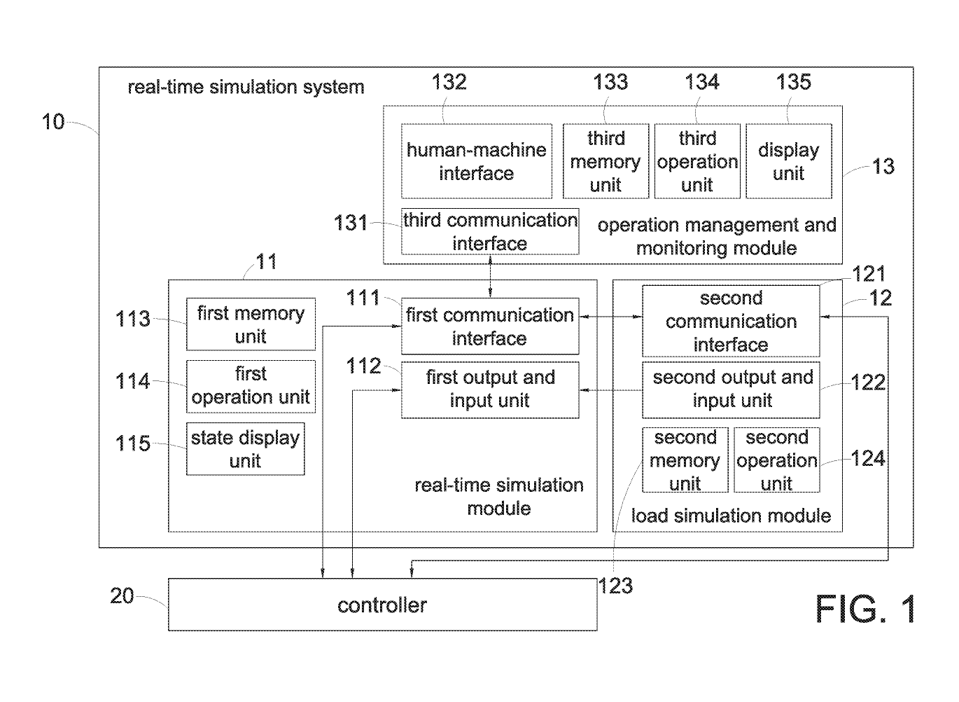

FIG. 1 is a circuit diagram illustrating a real-time simulation system according to an embodiment of the present disclosure. As shown in FIG. 1, the real-time simulation system 10 is applied for testing a controller 20. The controller 20 outputs a control signal for controlling operations of a power converter and an AC motor of an AC motor driving system, and allows the AC motor to synchronously drive an operation of a mechanical load which is coupled to the AC motor. The real-time simulation system 10 includes a real-time simulation module 11, a load simulation module 12 and an operation management and monitoring module 13.

The real-time simulation module 11 constructs a first model. The first model simulates the dynamic behaviors of the power received by the power converter, the power converter and the AC motor coupled to the mechanical load. Before the real-time simulation module 11 receives the control signal outputted from the controller 20, the real-time simulation module 11 is in standby state. When the real-time simulation module 11 receives the control signal outputted from the controller 20, the real-time simulation module 11 substitutes the control signal into the first model and starts the simulation program so as to generate a first simulation result.

In addition, the real-time simulation module 11 includes a first communication interface 111 and at least one first output and input unit 112, for example the single first output and input unit 112 shown in FIG. 1. When the real-time simulation system 10 is electrically connected with the controller 20, the first output and input unit 112 receives the control signal outputted from the controller 20 and transmits the first simulation result to the controller 20. In an embodiment, when the real-time simulation system 10 is electrically connected with the controller 20, the first communication interface 111 can communicate with the controller 20, which allows the real-time simulation module 11 to communicate with the controller 20.

The load simulation module 12 constructs a second model, which simulates the dynamic behaviors of the mechanical load, so as to generate a second simulation result by the simulation program. In addition, the load simulation module 12 includes a second communication interface 121 and at least one second output and input unit 122, for example the single second output and input unit 122 shown in FIG. 1. The second communication interface 121 communicates with the first communication interface 111, which allows the real-time simulation module 11 to communicate with the load simulation module 12. The second output and input unit 122 is electrically connected with the first output and input unit 112.

When the load simulation module 12 generates the second simulation result, the second simulation result is transmitted to the first output and input unit 112 via the second output and input unit 122, or transmitted to the first communication interface 111 via the second communication interface 121. Therefore, the real-time simulation module 11 can adjust the simulation program to the first model in accordance with the second simulation result. For example, the real-time simulation module 11 can adjust the load torque value of the mechanical load coupled to the AC motor which is simulated by the real-time simulation module 11.

The operation management and monitoring module 13 instantaneously monitors the operations of the real-time simulation module 11 and the load simulation module 12. The operation management and monitoring module 13 includes a third communication interface 131, a display unit 135 and a human-machine interface 132. The third communication interface 131 communicates with the first communication interface 111, which allows the operation management and monitoring module 13 to communicate with the real-time simulation module 11. Moreover, the third communication interface 131 communicates with the second communication interface 121 via the first communication interface 111, which allows the operation management and monitoring module 13 to communicate with the load simulation module 12. Preferably but not exclusively, the display unit 135 is a display panel. The display unit 135 displays the operation states of the real-time simulation module 11 and the load simulation module 12, the first simulation result and the second simulation result. The human-machine interface 132 receives a user command. According to the user command, the human-machine interface 132 sets the required relative parameters of the first model via the third communication interface 131 and the first communication interface 111. Moreover, the human-machine interface 132 sets the required relative parameters of the second model via the third communication interface 131, the first communication interface 111 and the second communication interface 121. The human-machine interface 132 can be a keyboard or a touch screen, but not exclusively.

From the above descriptions, it is known that the real-time simulation system 10 of the present disclosure constructs and simulates the dynamic behaviors of the power received by the power converter, the power converter and the AC motor coupled to the mechanical load through the real-time simulation module 11. Moreover, the real-time simulation system 10 constructs and simulates the dynamic behaviors of the mechanical load through the load simulation module 12. Therefore, the real-time simulation system 10 is usable for testing the controller 20. That is, the controller 20 doesn't need to be tested on real machines so that the cost for testing the controller 20 is reduced, and the safety of the operator is enhanced.

In addition, the real-time simulation system 10 allows the operation management and monitoring module 13 to communicate with the real-time simulation module 11 and the load simulation module 12 via the communications among the first communication interface 111, the second communication interface 121 and the third communication interface 131. Therefore, the display unit 135 can display the operation states of the real-time simulation module 11 and the load simulation module 12, the first simulation result and the second simulation result. Meanwhile, the human-machine interface 132 receives the user command so as to set the required relative parameters of the first model and the second model. Consequently, the real-time simulation system 10 of the present disclosure can instantaneously monitor and adjust the simulation, and the complexity and the time for simulation are reduced.

Moreover, the real-time simulation system 10 is independent from the controller 20. Namely, the controller 20 doesn't need to be included in the operation loop of the real-time simulation system 10. The real-time simulation system 10 only needs to receive the control signal outputted from the controller 20 and transmit the required information of the test back to the controller 20 via the first communication interface 111 or the first output and input unit 112. Consequently, the real-time simulation system 10 can be applied in all kinds of controllers 20 and provide plug and play effects. Therefore, the applicability of the real-time simulation system 10 of the present disclosure is improved.

Furthermore, the real-time simulation module 11 of the present disclosure constructs and simulates the dynamic behaviors of the power received by the power converter, the power converter and the AC motor coupled to the mechanical load. The load simulation module 12 simulates the dynamic behaviors of the mechanical load. Therefore, the real-time simulation module 11 can be formed by the relatively high-level operation architecture, and the load simulation module 12 can be formed by the relatively low-level operation architecture. Consequently, the wastage of the operation resource can be avoided. Therefore, the constitution cost of the real-time simulation system 10 of the present disclosure is reduced.

In an embodiment, as shown in FIG. 1, the real-time simulation module 11 includes a first memory unit 113, a first operation unit 114 and a state display unit 115. The first memory unit 113 can store the first model and the first simulation result. The first operation unit 114 can be a field programmable gate array (FPGA), but not exclusively. The first operation unit 114 operates the required program of the real-time simulation module 11. For example, the first operation unit 114 can read the first model stored in the first memory unit 113. As the real-time simulation module 11 receives the control signal transmitted from the controller 20, the real-time simulation module 11 substitutes the control signal into the first model and starts the program for generating the first simulation result. The state display unit 115 displays the work state (such as powering, simulating, abnormal, etc.). Preferably but not exclusively, the state display unit 115 is an indicator lamp. In addition, the first model can describe the time-varying dynamic behaviors of the AC motor coupled to the mechanical load, the power received by the power converter, and the power converter by means of mathematics (such as differential equations). The operation management and monitoring module 13 receives the user command via the human-machine interface 132 and reloads the first model or the parameters of the first model stored in the first memory unit 113 via the third communication interface 131 and the first communication interface 111.

The load simulation module 12 includes a second operation unit 124 and a second memory unit 123. The second memory unit 123 is able to store the second model and the second simulation result. Since the required operation speed of the second operation unit 124 is slower than that of the first operation unit 114, the second operation unit 124 can be a microcontroller unit (MCU), but not exclusively. The second operation unit 124 operates the required program of the load simulation module 12. For example, the second operation unit 124 can read the second model stored in the second memory unit 123 and operates the program for generating the second simulation result. In addition, the second model can describe the time-varying dynamic behaviors of the mechanical load by means of mathematics (such as differential equations). The operation management and monitoring module 13 receives the user command via the human-machine interface 132. Via the third communication interface 131, the first communication interface 111 and the second communication interface 121, the operation management and monitoring module 13 is able to reload the second model stored in the second memory unit 123 or modify the parameters of the second model.

As described above, the real-time simulation module 11 constructs and simulates the dynamic behaviors of the AC motor coupled to the mechanical load, and the load simulation module 12 constructs and simulates the dynamic behaviors of the mechanical load. Since the dynamic behaviors of the mechanical load affects the dynamic behaviors of the AC motor coupled to the mechanical load, the second simulation result of the load simulation module 12 actually affects the simulation program to the first model by the real-time simulation module 11. Therefore, the real-time simulation module 11 needs to receive the second simulation result simulated by the load simulation module 12 so as to adjust the simulation program to the first model.

In an embodiment, the real-time simulation module 11 receives the second simulation result generated by the second operation unit 124 via the first output and input unit 112 and the second output and input unit 122. Therefore, the real-time simulation module 11 can adjust the simulation program to the first model according to the second simulation result. In another embodiment, the real-time simulation module 11 reads the second simulation result stored in the second memory unit 123 via the first communication interface 111 and the second communication interface 121. Therefore, the real-time simulation module 11 can adjust the simulation program to the first model according to the second simulation result.

In addition, the first output and input unit 112 of the real-time simulation module 11 receives the control signal outputted from the controller 20 and transmits the first simulation result to the controller 20. The second output and input unit 122 of the load simulation module 12 outputs the second simulation result to the first output and input unit 112. Therefore, the type of the first output and input unit 112 must correspond to the signal type of the control signal outputted from the controller 20, and the type of the second output and input unit 122 must correspond to the type of the first output and input unit 112. In an embodiment, the control signal outputted from the controller 20 is a digital signal. Under this circumstance, the first output and input unit 112 is correspondingly a digital output and input unit, and the second output and input unit 122 is correspondingly a digital output and input unit. In another embodiment, the control signal outputted from the controller 20 is an analog signal. Under this circumstance, the first output and input unit 112 is correspondingly an analog output and input unit, and the second output and input unit 122 is correspondingly an analog output and input unit.

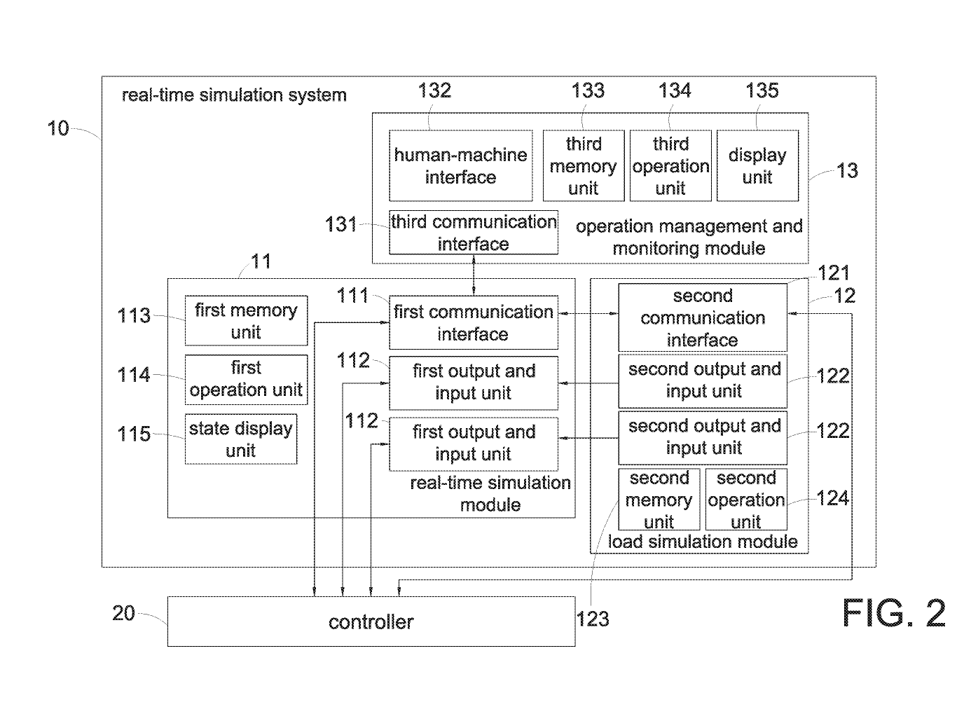

In an embodiment, as shown in FIG. 2, the real-time simulation module 11 includes two first output and input units 112. One of the two first output and input units 112 is a digital output and input unit, and the other first output and input unit 112 is an analog output and input unit. The load simulation module 12 also includes two second output and input units 122. One of the two second output and input units 122 is a digital output and input unit, and the other second output and input unit 122 is an analog output and input unit. Consequently, if the control signal outputted from the controller 20 is the digital signal, the real-time simulation module 11 communicates with the controller 20 via the first output and input unit 112 which is the digital output and input unit. If the control signal outputted from the controller 20 is the analog signal, the real-time simulation module 11 communicates with the controller 20 via the first output and input unit 112 which is the analog output and input unit. Moreover, the first output and input unit 112 which is the digital output and input unit communicates with the second output and input unit 122 which is the digital output and input unit. The first output and input unit 112 which is the analog output and input unit communicates with the second output and input unit 122 which is the analog output and input unit.

As shown in FIG. 1, the operation management and monitoring module 13 further includes a third memory unit 133 and a third operation unit 134. The third memory unit 133 provides the storage function required by the operation management and monitoring module 13. Moreover, the third memory unit 133 receives and stores the first simulation result via the third communication interface 131 and the first communication interface 111. The third memory unit 133 receives and stores the second simulation result via the third communication interface 131, the first communication interface 111 and the second communication interface 121. The third operation unit 134 operates programs of the operation management and monitoring module 13. In addition, when the real-time simulation module 11 and the load simulation module 12 respectively simulate plural times, the third memory unit 133 stores plural first simulation results and plural second simulation results. Under this circumstance, the human-machine interface 132 can receive the user command to let the third operation unit 134 compare different simulation results with each other, and display the comparison result on the display unit 135.

In summary, the present disclosure provides a real-time simulation system for testing the controller. The real-time simulation module of the real-time simulation system constructs the first model simulating the dynamic behaviors of the power received by the power converter, the power converter and the AC motor coupled to the mechanical load. The load simulation module constructs the second model simulating the dynamic behaviors of the mechanical load. In addition, the operation management and monitoring module is able to communicate with the real-time simulation module and the load simulation module and set the required relative parameters of the first model and the second model. Moreover, the real-time simulation system is independent from the controller. Therefore, the controller doesn't need to be included in the operation loop of the real-time simulation system. Furthermore, the real-time simulation module can be formed by the high-level operation architecture, and the load simulation module can be formed by the low-level operation architecture. Consequently, the real-time simulation system of the present disclosure has advantages of higher safety, higher applicability, higher computational resource efficiency and lower cost.

While the disclosure has been described in terms of what is presently considered to be the most practical and preferred embodiments, it is to be understood that the disclosure needs not be limited to the disclosed embodiment.

What is claimed is:

1. A real-time simulation system for testing a controller, wherein the controller outputs a control signal for controlling operations of a power converter and an AC motor and allows the AC motor to drive a mechanical load synchronously, the real-time simulation system comprising:
a real-time simulation module constructing a first model simulating dynamic behaviors of a power received by the power converter, the power converter and the AC motor coupled to the mechanical load, wherein the real-time simulation module substitutes the control signal into the first model and operates a simulation program for generating a first simulation result when the real-time simulation module receives the control signal, the real-time simulation module comprises a first communication interface and at least one first output and input unit, and the at least one first output and input unit transmits the first simulation result to the controller and receives the control signal;
a load simulation module constructing a second model simulating dynamic behaviors of the mechanical load and generating a second simulation result by a simulation program, wherein the load simulation module comprises a second communication interface and at least one second output and input unit, the second communication interface communicates with the first communication interface, and the second simulation result is transmitted to the at least one first output and input unit via the at least one second output and input unit, or transmitted to the first communication interface via the second communication interface, for allowing the real-time simulation module to adjust the simulation program to the first model according to the second simulation result; and
an operation management and monitoring module monitoring operations of the real-time simulation module and the load simulation module, wherein the operation management and monitoring module comprises a human-machine interface, a display unit and a third communication interface, the third communication interface communicates with the first communication interface for allowing the operation management and monitoring module and the real-time simulation module to communicate with each other, the third communication interface communicates with second communication interface via the first communication interface for allowing the operation management and monitoring module and the load simulation module to communicate with each other, the display unit displays operation states of the real-time simulation module and the load simulation module, the first simulation result and the second simulation result, the human-machine interface receives a user command and sets parameters of the first model according to the user command via the third communication interface and the first communication interface, and the human-machine interface sets parameters of the second model according to the user command via the third communication interface, the first communication interface and the second communication interface.

2. The real-time simulation system according to claim 1, wherein the real-time simulation module further comprises:
a first memory unit storing the first model and the first simulation result;
a first operation unit reading the first model stored in the first memory unit, substituting the control signal into the first model and operating the simulation program for generating the first simulation result; and
a state display unit displaying a work state of the real-time simulation module.

3. The real-time simulation system according to claim 2, wherein the first operation unit is a field programmable gate array.

4. The real-time simulation system according to claim 1, wherein the load simulation module further comprises:
a second memory unit storing the second model and the second simulation result; and
a second operation unit reading the second model stored in the second memory unit and operating the simulation program for generating the second simulation result.

5. The real-time simulation system according to claim 4, wherein the second operation unit is a microcontroller unit.

6. The real-time simulation system according to claim 4, wherein the real-time simulation module receives the second simulation result generated by the second operation unit via the at least one first output and input unit and the at least one second output and input unit, and the real-time simulation module adjusts the simulation program to the first model according to the second simulation result.

7. The real-time simulation system according to claim 4, wherein the real-time simulation module reads the second simulation result stored in the second memory unit via the first communication interface and the second communication interface, and the real-time simulation module adjusts the simulation program to the first model according to the second simulation result.

8. The real-time simulation system according to claim 1, wherein if the real-time simulation doesn't receive the control signal, the real-time simulation module is in standby state.

9. The real-time simulation system according to claim 1, wherein the at least one first output and input unit is a digital output and input unit, and the at least one second output and input unit is a digital output and input unit.

10. The real-time simulation system according to claim 1, wherein the at least one first output and input unit is an analog output and input unit, and the at least one second output and input unit is an analog output and input unit.

11. The real-time simulation system according to claim 1, wherein the at least one first output input unit comprises two first output and input units, one of the two first output and input units is a digital output and input unit, and the other first output and input unit is an analog output and input unit, and wherein the at least one second output and input unit comprises two second output and input units, one of the two second output and input units is a digital output and input unit, and the other second output and input unit is an analog output and input unit.

12. The real-time simulation system according to claim 1, wherein the operation management and monitoring module comprises:
a third memory unit receiving and storing the first simulation result via the third communication interface and the first communication interface, and receiving and storing the second simulation result via the third communication interface, the first communication interface and the second communication interface; and
a third operation unit operating programs of the operation management and monitoring module.
